(19) United States
(12) Patent Application Publication
(10) Pub. No.: US 2020/0241500 A1
(43) Pub. Date: Jul. 30, 2020

(54) NUMERICAL CONTROL MACHINE TOOL PROCESSING PROGRAM SHARING METHOD

(71) Applicant: TAIWAN DEVELOPMENT INSTITUTE, TAICHUNG CITY (TW)

(72) Inventor: JIA MING SHYU, TAICHUNG CITY (TW)

(21) Appl. No.: 16/257,302

(22) Filed: Jan. 25, 2019

(51) Int. Cl. G05B 19/408; H04L 29/08

(52) U.S. Cl. CPC G05B 19/408; G05B 2219/31422; H04L 67/12; H04L 67/06

(57) ABSTRACT

A numerical control machine tool processing program sharing method includes steps, namely program upload, program verification and program download, whereby a processing program in a sharer's possession is uploaded to a database and then verified by administrators with a administration program. After a client has downloaded the processing program, the processing program is directly loaded onto a numerical control machine tool to process workpieces.

### FIELD OF THE INVENTION

The present disclosure relates to numerical control processing and, more particularly, to a numerical control machine tool processing program sharing method.

### BACKGROUND OF THE INVENTION

Although conventional numerical control machine tools are improved and innovated ceaselessly, they are nowadays still operated by workers to carry out computer-aided manufacturing (CAM); hence, the workers compile executable processing programs with CAM software and instructions. The instructions-based compilation involves criteria, such as processing process steps, selected cutting tools, shaft rotating speed, feed speed, tool path and cutting depth. Then, the processing programs are entered into a numerical control machine tool controller. The processing programs are executed to thereby process the workpiece according to the sequence of the instructions.

The programmers who compile the processing programs for use in CAM have to be familiar with the processing process flow and possess related programming skills. The phenomenon that the programmers are professionals and thus well-paid, coupled with the fact that the programmers must constitute part of the regular staff even if the amount of the processing programs to be developed is small, renders it impossible to cut labor costs incurred in the employment of the programmers. Furthermore, if the programmers employed are incompetent and thus often err, they will be unable to get high-quality processing program programming done by deadlines, thereby leading to a waste of human resources and reducing cost-effectiveness.

### SUMMARY OF THE INVENTION

It is an objective of the present disclosure to overcome the aforesaid drawbacks of the prior art and thus provide a numerical control machine tool processing program sharing method. The numerical control machine tool processing program sharing method allows a sharer to upload a processing program to a database for storage, allows an administrator to download the processing program and then verify it, allows a client to download the processing program from the database and then use it, thereby dispensing with the need to employ processing program programmers, and achieves high quality through compulsory verification of the processing program, so as to cut labor costs and enhance processing efficiency.

In order to achieve the above and other objectives, the present disclosure provides a numerical control machine tool processing program sharing method, comprising the steps described below.

Program upload: connecting communicatively a first communication device in a sharer's possession to a database through Internet, installing an operating interface on the first communication device, and uploading a processing program for a workpiece to the database for storage.

Program verification: connecting communicatively second communication devices in a plurality of administrators' possession to the database through the Internet to download the processing program, the second communication devices each having a built-in administration program, such that the second communication devices verify correction of the processing program with the administration program and then send the verified processing program to the database.

Program download: connecting communicatively a third communication device in a client's possession to the database through the Internet and installed with the operating interface, entering to the operating interface a search criterion, the search criterion being information pertaining to the workpiece to be processed, so as to search the database for the processing program which meets the search criterion, wherein, after the processing program which meets the search criterion has been found, it is directly downloaded for use.

In the program upload step, with the operating interface, the first communication device recognizes, classifies and codes graphics drawn of the workpiece by hand or by computer or workpiece images, wherein processing information and the processing program are uploaded to the database for storage, the processing information being based on a type of the numerical control machine tool for processing the workpiece with the processing program.

### BRIEF DESCRIPTION OF THE DRAWINGS

FIG. 1 is a block diagram of communication and connection between apparatuses used in a method according to an embodiment of the present disclosure;

FIG. 2 is a flowchart of program upload according to an embodiment of the present disclosure;

FIG. 3 is a flowchart of program verification according to an embodiment of the present disclosure; and

FIG. 4 is a flowchart of program download according to an embodiment of the present disclosure.

### DETAILED DESCRIPTION OF THE PREFERRED EMBODIMENTS

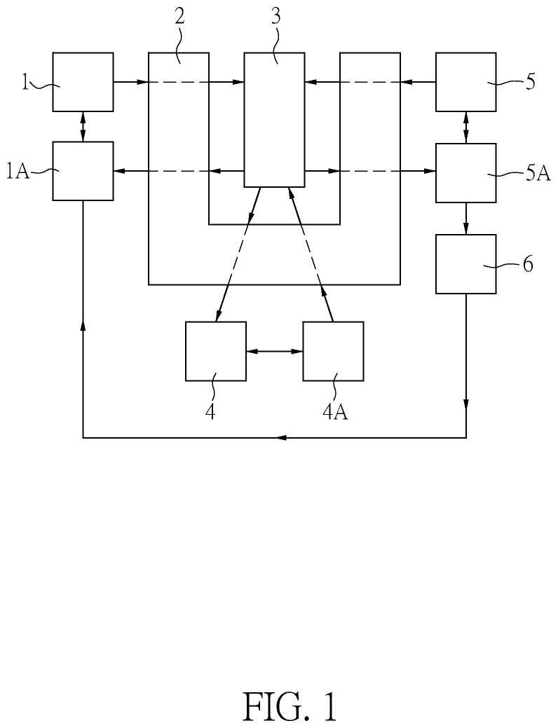

Referring to FIG. 1 through FIG. 4, the present disclosure provides, in a preferred embodiment thereof, a numerical control machine tool processing program sharing method, comprising the steps of program upload, program verification and program download, as described below.

As shown in FIG. 1, the steps of the method, namely program upload, program verification and program download, are performed with first communication devices 1, 1A, second communication devices 4, 4A and third communication devices 5, 5A communicatively connected to a database 3 through the Internet 2, and the third communication devices 5, 5A are communicatively connected to a numerical control machine tool controller 6. The first communication devices 1, 1A, second communication devices 4, 4A or third communication devices 5, 5A are smartphones, tablets, desktops or laptops, and this embodiment is exemplified by smartphones. The database 3 is a cloud database or a local area network database, and this embodiment is exemplified by a cloud database.

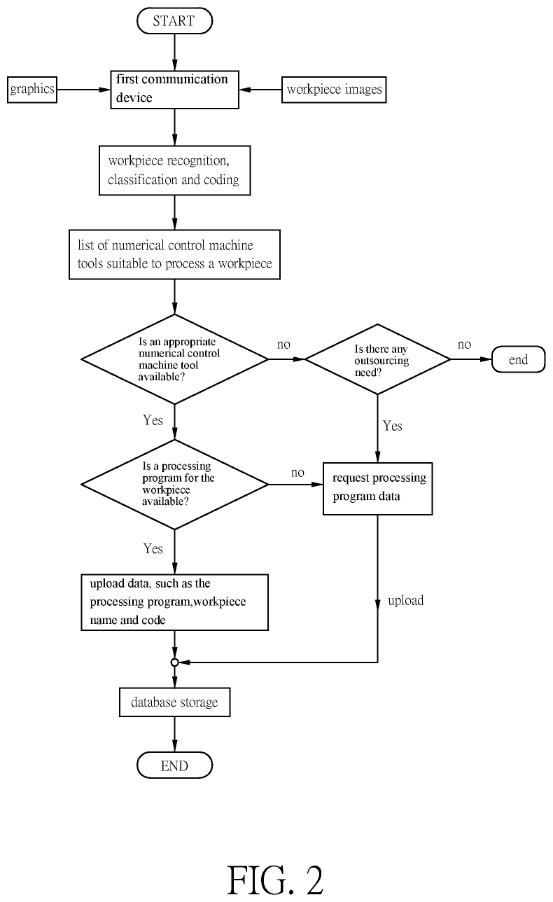

As illustrated by the flowchart shown in FIG. 2, in the program upload step, the first communication device 1 in a sharer's possession is communicatively connected to the database 3 through the Internet 2 as shown in FIG. 1, and the first communication device 1, which an operating interface (not shown) is installed on, uploads a processing program for a workpiece to the database 3 for storage. In the program upload step of this embodiment, with the operating interface, the first communication device 1 recognizes, classifies and codes graphics drawn of the workpiece by hand or by computer or workpiece images and uploads processing information and the processing program to the database 3 for storage, wherein the processing information is based on the type of the numerical control machine tool for processing the workpiece with the processing program.

As illustrated by the flowchart shown in FIG. 2, the processing program and the processing information are compiled by the sharer or by an outsourced manufacturer paid by the sharer. Therefore, after the graphics or workpiece images have been recognized, classified and coded, a list of numerical control machine tools suitable to process the workpiece is compiled. If the sharer has the list of numerical control machine tools for the workpiece and has the processing program for the workpiece, the sharer will upload them to the database 3 for storage. If the sharer does not have the list of numerical control machine tools for the workpiece and does not have an outsourcing need, the process flow of the method will end, otherwise the sharer will present a processing program need and upload the list of numerical control machine tools to the database 3 for storage.

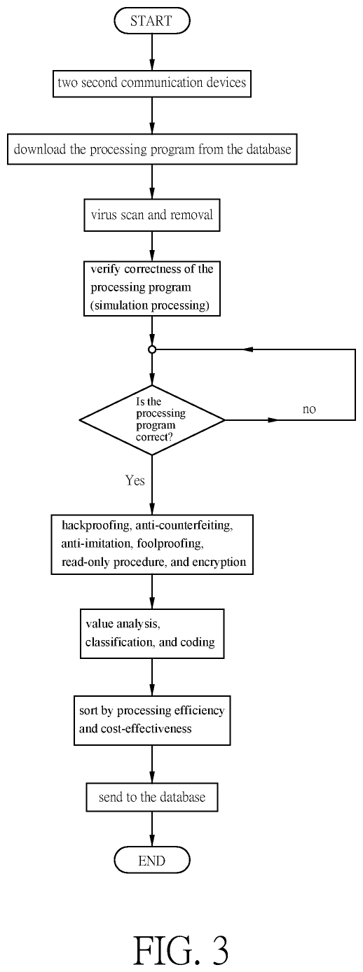

As illustrated by the flowchart shown in FIG. 3, in the program verification step, the second communication devices 4, 4A in the plurality of administrators' possession are each communicatively connected to the database 3 through the Internet 2 to download the processing program. The second communication devices 4, 4A each have a built-in administration program (not shown) for verifying the correctness of the processing program, and then the processing program thus verified is uploaded to the database 3 for storage.

As illustrated by the flowchart shown in FIG. 3, in the program verification step, the second communication devices 4, 4A perform parallel operations, and the plurality of administrators downloads the processing program to the second communication devices 4, 4A to therefore allow the second communication devices 4, 4A to perform virus scan and removal simultaneously and verify the correctness of the processing program by simulation processing so as to ensure the stability of verification results. The second communication devices are conducive to division of labor. In this embodiment, the second communication devices 4, 4A are exemplified by two smartphones, one of which will keep operating if the other has its operation suspended as a result of negative effects of communication and interference while the program verification step is being carried out, i.e., the second communication devices function as a standby device to each other, thereby enhancing the reliability of the performance of the steps.

As illustrated by the flowchart shown in FIG. 3, in the program verification step, after the correctness of the processing program has been verified, the processing programs undergo hackproofing, anti-counterfeiting, anti-imitation, foolproofing and/or read-only procedure, and encryption, undergo value analysis, classification, and coding, are sorted by processing efficiency and cost-effectiveness, so as to become application software before being sent to the database 3 for storage.

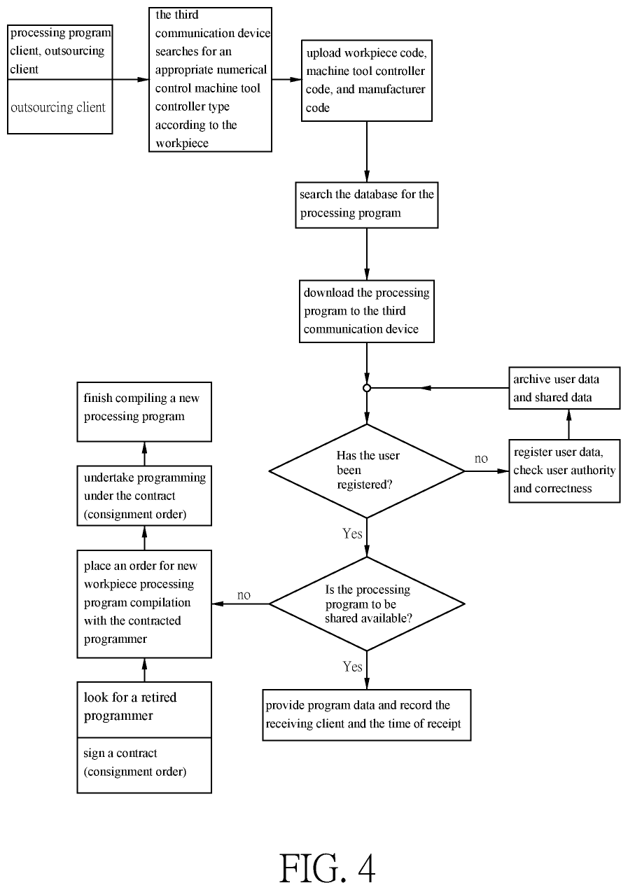

As illustrated by the flowchart shown in FIG. 4, in the program download step, the third communication devices 5, 5A in a client's possession are communicatively connected to the database 3 through the Internet 2 and installed with the operating interface. A search criterion, i.e., information pertaining to the workpiece to be processed, is entered into the operating interface so as to search the database 3 for the processing program which meets the search criterion. After the processing program which meets the search criterion has been found, it is directly downloaded for use, that is, being loaded to the numerical control machine tool controller 6 as shown in the diagram, so as to execute the processing of the workpiece. In this embodiment, when the client has a workpiece to be processed, graphics of the workpiece are drawn by hand or by computer-aided drafting. After being retrieved, graphics images of the workpiece are entered into the operating interface, and the administration program recognizes features of the images so as to search the database 3 for the processing program which meets the search criterion. If the processing program which meets the search criterion is found, the code of the processing program will be provided to the client.

As illustrated by the flowchart shown in FIG. 4, in the program download step, the search criterion includes a workpiece code, a machine tool controller code and client data. After the processing program which meets the search criterion has been searched for and found, the processing program will be downloaded from the database 3, and both the client receiving the processing program and the time of receipt are provided and recorded. In the program download step, if the processing program which meets the search criterion is not found in the database, the client will request the programming of the processing program and look for a programmer. Upon a conclusion of a contract (consignment order), the programmer compiles the processing program and sends it to the database. After the processing program has been verified, the client downloads the processing program. The programmer, who is chosen from retired programmers of processing programs for numerical control machine tools, signs a contract (consignment order) under which the programmer compiles the processing program. After the processing program compiled has been verified with the administration program, the administrator pays the programmer under the contract.

As illustrated by the flowchart shown in FIG. 4, in the program download step, the client data is sent to the second communication devices 4, 4A to undergo identity verification with the administration program. It is only when the client data passes the identity verification that the downloading of the processing program begins. In this embodiment, user registration is required, that is, the result of the identity verification depends on whether the client has been registered. If the client has been registered, the client can download the processing program. If the client has not been registered, it will be necessary to register user data, check user authority and correctness, and archive user data and shared data. When the client obtains the code of the processing program and thus requests the processing program from the database 3, the built-in administration program of the second communication devices 4, 4A checks the user data registered by the client, keeps the client's track record of uploading the processing program in accordance with the shared data, and thus determines the amount of the fee to charge the client for downloading the processing program. For instance, the sharer is permitted to download the processing program at a discount or free of charge when found to be willing to upload the processing program, or at full price when found to be unwilling to upload the processing program. The sharer will be denied access to the processing program, if the sharer has a poor track record of uploading the processing program.

The numerical control machine tool processing program sharing method of the present disclosure has advantages described below.

First, the numerical control machine tool processing program sharing method of the present disclosure provides a sharing platform to manufacturers such that the manufacturers can share existing processing programs, so as to not only dispense with the need for regular presence of processing program programmers, but also cut labor costs, because a client who has a workpiece to be processed with a numerical control machine tool can have the workpiece processed with a numerical control machine tool operated by an appropriate, shared processing program.

Second, the numerical control machine tool processing program sharing method of the present disclosure allows the client to find an appropriate processing program soon by a search criterion and with the third communication devices 5, 5A communicatively connected to the database 3; hence, the hired programmer need not perform programming and simulation from scratch, so as to avoid a waste of time and thus save time.

Third, the processing program uploaded to the database must have its correctness verified in the program verification step in order to be downloaded; hence, the usability of the downloaded processing program is ensured, so as to preclude any processing process failure otherwise caused by a wrong processing program. The processing programs are not only verified for their correctness but also sorted by processing efficiency and cost-effectiveness. Hence, the administrators analyze and compare the processing programs, and thus the client can sort the processing programs by a search criterion, for example, the speed of processing the processing programs for the same workpiece or processing precision, allowing the client to compare and choose an appropriate processing program.

Fourth, the programmer hired to compile the processing program and paid case by case was previously a retired processing programmer familiar with numerical control machine tools. This not only enables programmer retirees to make good use of their expertise and knowledge and be rewarded by compiling the processing programs, but also allows the client to access usuable processing programs and thus provides a win-win solution to the sharer and the client.

What is claimed is:

1. A numerical control machine tool processing program sharing method, comprising the steps of:
program upload: connecting communicatively a first communication device in a sharer's possession to a database through Internet, installing an operating interface on the first communication device, and uploading a processing program for a workpiece to the database for storage;
program verification: connecting communicatively second communication devices in a plurality of administrators' possession to the database through the Internet to download the processing program, the second communication devices each having a built-in administration program, such that the second communication devices verify correction of the processing program with the administration program and then send the verified processing program to the database; and
program download: connecting communicatively a third communication device in a client's possession to the database through the Internet and installed with the operating interface, entering to the operating interface a search criterion, the search criterion being information pertaining to the workpiece to be processed, so as to search the database for the processing program which meets the search criterion, wherein, after the processing program which meets the search criterion has been found, it is directly downloaded for use, wherein, in the program upload step, with the operating interface, the first communication device recognizes, classifies and codes graphics drawn of the workpiece by hand or by computer or workpiece images, wherein processing information and the processing program are uploaded to the database for storage, the processing information being based on a type of the numerical control machine tool for processing the workpiece with the processing program.

2. The numerical control machine tool processing program sharing method of claim 1, wherein the processing information and the processing program for the workpiece are compiled by the sharer or by an outsourced manufacturer paid by the sharer.

3. The numerical control machine tool processing program sharing method of claim 1, wherein, in the program verification step, the plurality of second communication devices performs parallel operations, which require the plurality of administrators to download the processing program to the second communication devices, the second communication devices to perform virus scan and removal simultaneously, and correctness of the processing program to be verified by simulation processing.

4. The numerical control machine tool processing program sharing method of claim 3, wherein, in the program verification step, upon verification of the correctness of the processing program, the processing programs undergo hackproofing, anti-counterfeiting, anti-imitation, foolproofing and/or read-only procedure, and encryption, undergo value analysis, classification, and coding, are sorted by processing efficiency and cost-effectiveness, so as to become application software before being sent to the database.

5. The numerical control machine tool processing program sharing method of claim 1, wherein, in the program download step, the search criterion includes a workpiece code, a machine tool controller code and client data, wherein, after the processing program which meets the search criterion has been searched for and found in the database, both the client receiving the processing program and the time of receipt are provided and recorded.

6. The numerical control machine tool processing program sharing method of claim 5, wherein, in the program download step, if the processing program which meets the search criterion is not found in the database, the client will request the programming of the processing program and look for a programmer, wherein, upon consignment, the programmer compiles the processing program and sends it to the database, wherein, after the processing program has been verified, the client downloads the processing program.

7. The numerical control machine tool processing program sharing method of claim 6, wherein, in the program download step, the client data is sent to the second communication devices to undergo identity verification with the administration program, and it is only when the client data passes the identity verification that the downloading of the processing program begins.

8. The numerical control machine tool processing program sharing method of claim 1, wherein the first communication device, second communication devices or third communication device is a smartphone, a tablet, a desktop or a laptop.

9. The numerical control machine tool processing program sharing method of claim 1, wherein the database is a cloud database or a local area network database.
